(19) United States
(12) Patent Application Publication
(10) Pub. No.: US 2026/0323194 A1
(43) Pub. Date: Oct. 15, 2026

(54) MOTORCYCLE AUDIO SYSTEM AND KIT

(71) Applicant: Thomas Eugene Pinkney, Savannah, GA (US)

(72) Inventor: Thomas Eugene Pinkney, Savannah, GA (US)

(21) Appl. No.: 19/647,806

(22) Filed: Apr. 14, 2026

Related U.S. Application Data
(60) Provisional application No. 63/788,935, filed on Apr. 15, 2025.

(51) Int. Cl. H04R 1/02; B62J 1/28; B62J 17/10; B62J 45/10; H04R 1/22

(52) U.S. Cl. CPC H04R 1/025; B62J 17/10; B62J 45/10; H04R 1/026; B62J 1/28; H04R 1/22; H04R 2420/07; H04R 2499/13

(57) ABSTRACT

Aspects of the present disclosure describe a motorcycle or sports bike audio system and kit, with configurable design utilizing mountable enclosures connected to an amplifier and a wireless signal receiving dongle audio playback, configured with a streamlined design configured to contour to the motorcycle or sports bike with a factory look providing quality audio and maintaining safety and performance of the motorcycle or sports bike.

### CROSS-REFERENCE TO RELATED APPLICATIONS

The present application claims the benefit of U.S. Provisional Patent Application Ser. No. 63/788,935, filed Apr. 15, 2025, the entire contents of which are specifically incorporated herein by reference.

### FIELD

The present technology is generally related to audio systems for motorcycles, and more particularly to sport bike audio systems and kits therefor.

### BACKGROUND

Traditional audio for motorcycles is provided through headsets or helmets, which headsets or helmets may be provided via a variety of physical configurations and via wired or wireless technology.

The present disclosure recognizes that there is a need in the art for audio delivery systems that are not reliant upon such traditional configurations.

### SUMMARY

The techniques of this disclosure generally relate to motorcycle audio systems, and more particularly and advantageously to sport bike audio systems and kits therefor.

In an exemplary aspect of the present disclosure, the audio system is provided as one or more mounted or mountable components that contain an audio driver and a component configured to receive audio signals from an audio source.

In exemplary embodiments the one or more mounted or mountable components include one or more enclosures configured to house one or more audio drivers. In further exemplary embodiments, the one or more enclosures are configured to mount to the motorcycle (or sport bike) to provide a factory look, such that it appears that the audio system originally came from the motorcycle manufacturer. In further exemplary aspects, the enclosure(s) comprise a durable plastic, such as acrylonitrile butadiene styrene (ABS) or other similar plastics.

In further exemplary aspects, the audio system is provided as a kit configured to bolt on or otherwise attach to an existing motorcycle, e.g., via screws such as stainless steel screws, via double sided tape, e.g., 3M™ double sided tape, etc.

In further exemplary aspects, the audio system includes multiple mounted or mountable components, each with an audio driver. In exemplary aspects, this comprises plural connected or separate speaker enclosures mounted to the motorcycle, e.g., 2, 3, 4 or more. In exemplary aspects, the multiple mounted or mountable components comprise multiple pods configured to accept one of a plurality of audio driver diameter sizes, e.g., 3.5 inches, 4 inches, 5.25 inches, 6.5 inches, etc., including non-circular speakers. In exemplary aspects, such multiple enclosures are provided as a kit allowing for partial installations over time on different positions of the motorcycle, or for full installation on those parts of the motorcycle where the enclosures are configured to mount.

In further exemplary aspects, different pods are configured to mount to different locations on the motorcycle, e.g., on an air duct cover of a sports bike at the upper front of the bike such that the audio driver(s) face the rider, at the rear top portion of the air duct cover as the mounting portion and the faring side panel as the back of the pod, such that it is configured as one or more lower mounted pods, as being form fitted to the underside of the seat near the wheel as a rear speaker pod, etc.

In further exemplary aspects, one or more pods, e.g., pods mounted in an upper front position, have a shaped cone design configured to be aerodynamic.

Additionally, in exemplary aspects, plural audio drivers may be provided in one enclosure, each of the same or of different audio ranges and sizes (e.g., a tweeter, a mid-range driver, a woofer, a subwoofer, etc.).

In exemplary aspects, the mounted component may also include one or more passive or active crossovers to provide separate audio frequencies to different driver types or configurations. This may be in a speaker enclosure or in a separate area of the mountable component, e.g., a discrete section thereof. In additional embodiments, one or more crossovers or audio signal splitters may be provided proximate to a central powered amplifier and then directed to any installed speaker pod.

In exemplary aspects, the audio source includes a wireless transmitter; and the mountable component includes a wireless receiver connected to the audio driver. In further exemplary embodiments, the wireless protocol is a Bluetooth protocol, though any other wireless audio protocols are contemplated herein. In further exemplary aspects, the audio source is a mobile phone that communicates with a Bluetooth dongle providing audio signal to a powered amplifier, e.g. a 12 volt amp, that is connected via cable or connector (e.g., one or more audio connectors, terminals, etc.) to the pod(s), either directly or via an active crossover, signal splitter or other audio signal distribution component.

Advantageously, exemplary embodiments disclosed herein provide for open air audio on a motorcycle or a sport bike, with one or more mountable components provided with audio from a source via a wireless protocol. Further, exemplary kits provide choice of placement and components for a full or partial but upgradable system that provides a factory look specific to the motorcycle (e.g., sports bike).

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a front perspective view of an exemplary speaker system pod, configured to mount on a lower front portion of a sport bike, in accordance with exemplary aspects of the present disclosure;

FIG. 2 is side elevation view of the exemplary speaker system pod illustrated in FIG. 1;

FIG. 3 is a front elevation view of another exemplary speaker system pod, configured to mount on an upper front portion of a sport bike, in accordance with exemplary aspects of the present disclosure;

FIG. 4 is a rear elevation view of the exemplary speaker system pod shown in FIG. 3;

FIG. 5 is a front perspective view of an exemplary front sport bike speaker system showing two mounted lower front pods and two upper mounted pods, in accordance with exemplary aspects of the present disclosure;

FIG. 6 is a front perspective view of an exemplary speaker system pod configured as a rear pod for a sports bike with an enclosure including two speaker drivers, in accordance with exemplary aspects of the present disclosure;

FIG. 7 is a front perspective view of an exemplary oval speaker pod configured to house a 6×9 inch speaker in a rear position on a sports bike, in accordance with exemplary aspects of the present disclosure;

FIG. 8 is a side perspective view of the exemplary speaker pod of FIG. 7;

FIG. 9 is a rear perspective view of an exemplary sports bike including mounted components from FIGS. 6-8, in accordance with exemplary aspects of the present disclosure;

FIG. 10 shows a front perspective views of 5.25 and 3.5 inch front upper pods configured to attach to a zx14 sports bike;

FIG. 11 shows a top perspective view of front upper pods configured to attach to a first and second generation Hayabusa sports bike;

FIG. 12 shows bottom perspective views of the pods illustrated in FIG. 11; and

FIG. 13 shows a top perspective view a dual driver rear pod for the first and second generation Hayabusa sports bike.

### DETAILED DESCRIPTION

As we have noted, the techniques of this disclosure generally relate to motorcycle audio systems, and more particularly and advantageously to sport bike audio systems and kits therefor.

In an exemplary aspect of the present disclosure, the audio system is provided as one or more mounted or mountable components that contain an audio driver and a component configured to receive audio signals from an audio source.

In exemplary embodiments the one or more mounted or mountable components include one or more enclosures configured to house one or more audio drivers. In further exemplary embodiments, the one or more enclosures are configured to mount to the motorcycle (or sport bike) to provide a factory look, such that it appears that the audio system originally came from the motorcycle manufacturer. In further exemplary aspects, the enclosure(s) comprise a durable plastic, such as acrylonitrile butadiene styrene (ABS) or other similar plastics.

In further exemplary aspects, the audio system is provided as a kit configured to bolt on or otherwise attach to an existing motorcycle, e.g., via screws such as stainless steel screws, via double sided tape, e.g., 3M™ double sided tape, etc.

In further exemplary aspects, the audio system includes multiple mounted or mountable components, each with an audio driver. In exemplary aspects, this comprises plural connected or separate speaker enclosures mounted to the motorcycle, e.g., 2, 3, 4 or more. In exemplary aspects, the multiple mounted or mountable components comprise multiple pods configured to accept one of a plurality of audio driver diameter sizes, e.g., 3.5 inches, 4 inches, 5.25 inches, 6.5 inches, etc., including non-circular speakers. In exemplary aspects, such multiple enclosures are provided as a kit allowing for partial installations over time on different positions of the motorcycle, or for full installation on those parts of the motorcycle where the enclosures are configured to mount.

In further exemplary aspects, different pods are configured to mount to different locations on the motorcycle, e.g., on an air duct cover of a sports bike at the upper front of the bike such that the audio driver(s) face the rider, at the rear top portion of the air duct cover as the mounting portion and the faring side panel as the back of the pod, such that it is configured as one or more lower mounted pods, as being form fitted to the underside of the seat near the wheel as a rear speaker pod, etc.

In further exemplary aspects, one or more pods, e.g., pods mounted in an upper front position, have a shaped cone design configured to be aerodynamic.

Additionally, in exemplary aspects, plural audio drivers may be provided in one enclosure, each of the same or of different audio ranges and sizes (e.g., a tweeter, a mid-range driver, a woofer, a subwoofer, etc.).

In exemplary aspects, the mounted component may also include one or more passive or active crossovers to provide separate audio frequencies to different driver types or configurations. This may be in a speaker enclosure or in a separate area of the mountable component, e.g., a discrete section thereof. In additional embodiments, one or more crossovers or audio signal splitters may be provided proximate to a central powered amplifier and then directed to any installed speaker pod.

In exemplary aspects, the audio source includes a wireless transmitter; and the mountable component includes a wireless receiver connected to the audio driver. In further exemplary embodiments, the wireless protocol is a Bluetooth protocol, though any other wireless audio protocols are contemplated herein. In further exemplary aspects, the audio source is a mobile phone that communicates with a Bluetooth dongle providing audio signal to a powered amplifier, e.g. a 12 volt amp, that is connected via cable or connector (e.g., one or more audio connectors, terminals, etc.) to the pod(s), either directly or via an active crossover, signal splitter or other audio signal distribution component.

Advantageously, exemplary embodiments disclosed herein provide for open air audio on a motorcycle or a sport bike, with one or more mountable components provided with audio from a source via a wireless protocol. Further, exemplary kits provide choice of placement and components for a full or partial but upgradable system that provides a factory look specific to the motorcycle (e.g., sports bike).

The following refers to the FIGURES, which presents an example of various speaker pods that are separately mountable to a specific sports bike, in this case a Kawasaki 14R. While the illustrated exemplary components are shaped to conform to the shape of the Kawasaki 14R, other configurations are contemplated herein that would conform to other sports bikes, and to other motorcycles in general. Further, while the illustrated exemplary embodiments described as individual or combinable as an upgradable kit, other components and other placements for different specific motorcycles are contemplated herein.

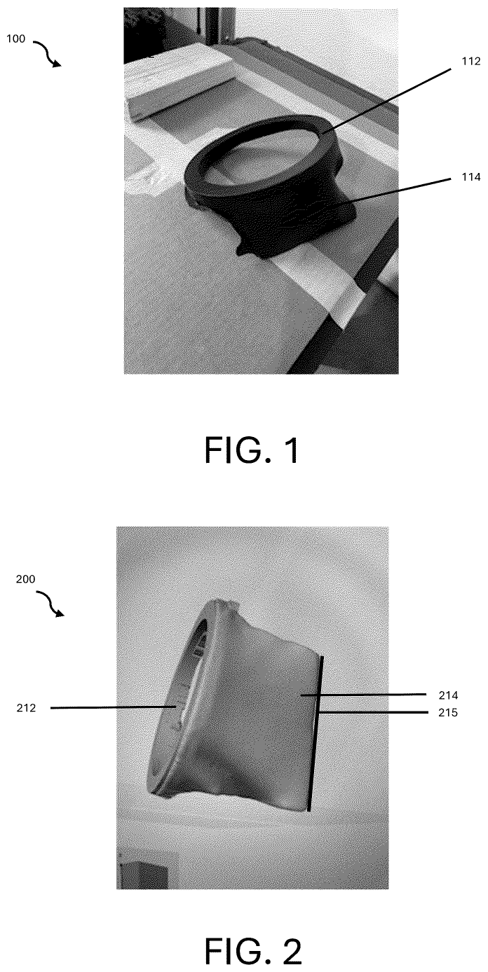

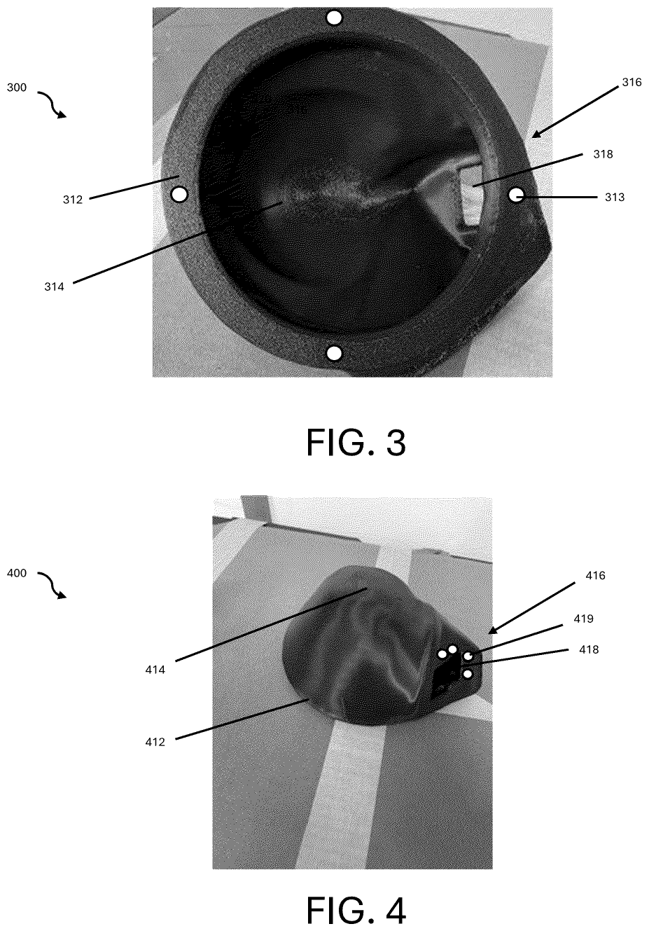

Referring now to FIG. 1 is a front perspective view of an exemplary speaker system pod, configured to mount on a lower front portion of a sport bike, is illustrated generally at 100. A driver mounting ring is shown at 112, which as has been noted can be sized to different speaker sizes. An enclosure/mounting portion is shown at 114, which is shaped to form fit to the faring side panel at the rear of the sport bike's air duct cover (not shown) to complete the enclosure. In exemplary embodiments, this enclosure is considered an add-on relative to the pod shown in FIG. 3.

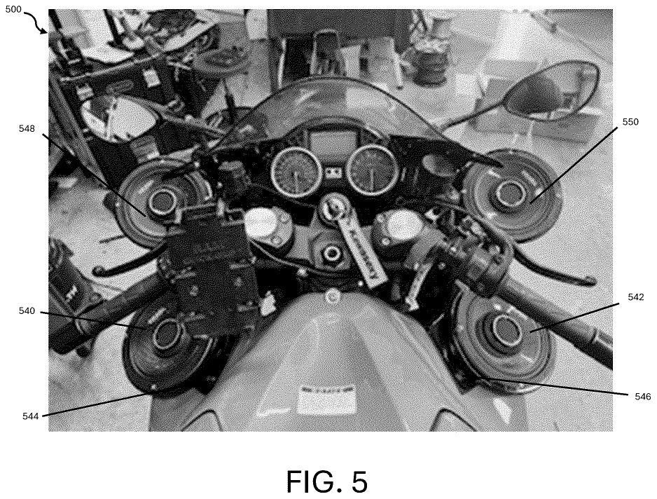

FIG. 2 shows a side elevation view of the exemplary speaker system pod illustrated in FIG. 1 generally at 200, with a different perspective of the driver mounting ring 212 and the enclosure mounting portion 214. This positioning provides for mounting (as can be seen at 215 with double sided tape and with screws in FIG. 5, though both tape and screws may be utilized) in a lower position, facing the rider and designed such that the rider is able to fully turn the handle bars to the right and the left. Further, the shaping of the enclosure provides for a contoured shape at the rear of the air duct cover that is that provides for an aerodynamic design minimizing or eliminating any noise and vibration, and avoiding loss of control during high wind speeds/high speed riding.

Referring now to FIG. 3, a front perspective view of an exemplary speaker system pod, configured to mount on an upper front portion of a sport bike, is illustrated generally at 300. A driver mounting ring is shown at 312 with driver mounting holes 313. As has been noted, the driver mounting ring can be sized to different speaker sizes. An enclosure/mounting portion is shown at 314, which is shaped to form fit to the front of the sport bike's air duct cover (not shown), with a cutout 316 configured to adapt to the air duct cover. While different sizes are contemplated herein, the illustrated exemplary pod is configured to retain a 6.5 inch woofer/driver.

FIG. 4 shows a side elevation view of the exemplary speaker system pod illustrated in FIG. 3 generally at 400, with a different perspective of the driver mounting ring 412 and the enclosure mounting portion 414, which also includes a cutout 418 configured to adapt to the air duct cover contours and screw mounting holes 419 (shown with four holes, though any number may be provided, with or without the additional use of double sided tape) configured to attach the enclosure mounting portion to the air duct cover. This positioning provides for mounting (as can be seen in FIG. 5) in an upper position, facing the rider and designed such that the rider is able to fully turn the handle bars to the right and the left. Further, the shaping of the enclosure provides for a cone shape from the front of the enclosure 416to the driver mounting ring that provides for an aerodynamic design minimizing or eliminating any noise and vibration, and avoiding loss of control during high wind speeds/high speed riding.

FIG. 5 shows a front perspective view of an exemplary front sport bike speaker system showing two mounted lower front pods 540, 542, with screws 544, 546 mounting the pods to the sport bike, and two upper mounted pods 548, 550, in accordance with exemplary aspects of the present disclosure. This Figure illustrates the streamlined, factory look for the front pods.

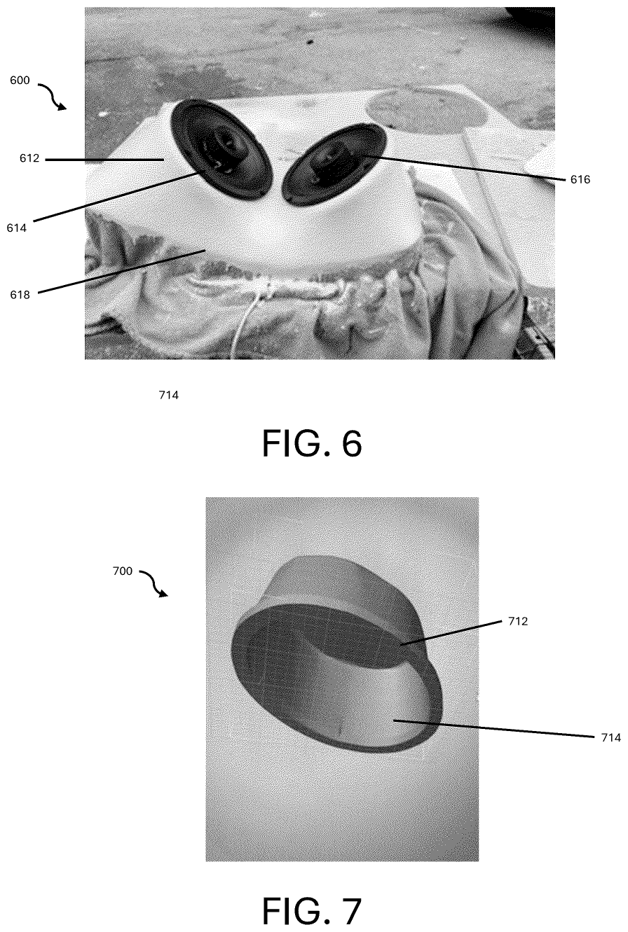

FIG. 6 shows a front perspective view of an exemplary speaker system pod configured as a rear pod for a sports bike with an enclosure including two speaker drivers generally at 600. Enclosure 612 houses two drivers 614, 616 and mounts at edge 618 (also as seen in FIG. 9). The illustrated exemplary rear pod is form fitted to the under side of the seat near and facing the rear wheel of the sport bike and is configured to house the two speakers in a non-parallel way (angled partially towards each other). The illustrated embodiment is configured to house two 6.5 inch speakers.

This pod, like those from FIGS. 1-5, are configured to not interfere with the normal performance or safety of the sports bike. While being large enough for robust sound production, it is also small enough so as not to interfere with the suspension or normal function of the sport bike.

While two 6.5 inch speakers are shown, other configurations are contemplated herein, e.g., one or more 6 inch, 8 inch or 10 inch speakers.

FIG. 7 shows a front perspective view of an exemplary oval speaker pod configured to house a 6×9 inch speaker in a rear position on a sports bike generally at 700. The driver mounting ring is shown at 712, with the enclosure shown at 714.

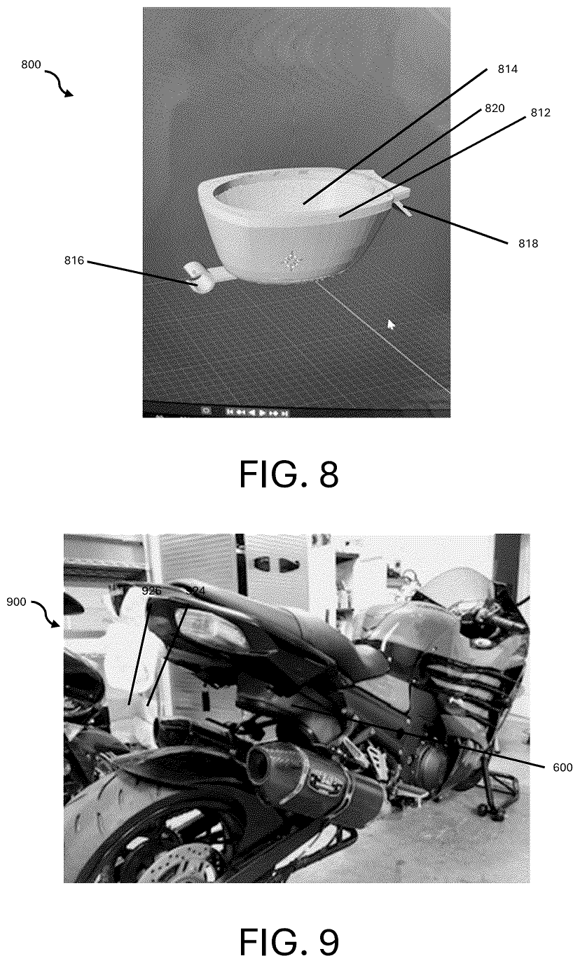

FIG. 8 is a side perspective view of the exemplary speaker pod of FIG. 7, shown generally at 800, and illustrating the driver mounting ring 812 and the enclosure 814.

FIG. 9 shows a rear perspective view of an exemplary sports bike generally at 900, including mounted components from FIGS. 6-8, though the image utilizes dual speaker pod 600, as shown.

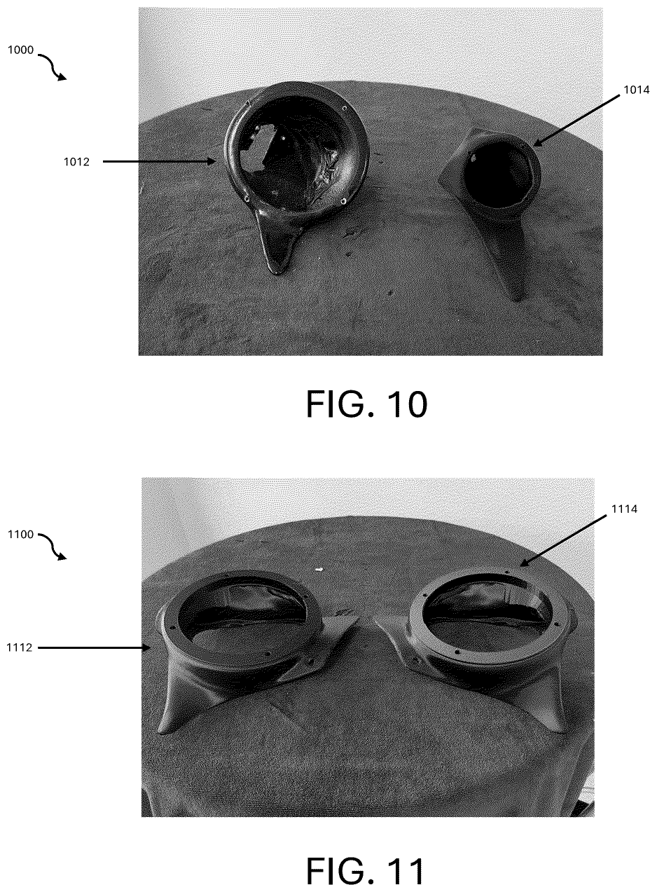

As has been noted, while FIGS. 1-9 show pods configured to mount to a Kawasaki 14R sports bike, other pod and driver configurations conformable to other sports bikes are contemplated herein, for example as per FIGS. 10-13.

For example, FIG. 10 shows generally at 1000 front perspective views of 5.25 and 3.5 inch front upper pods 1112, 114 configured to attach to a zx 14 sports bike.

FIG. 11 shows generally at 1100 top perspective views of front upper pods 1112, 1114 configured to attach to a first or second generation Hayabusa sports bike.

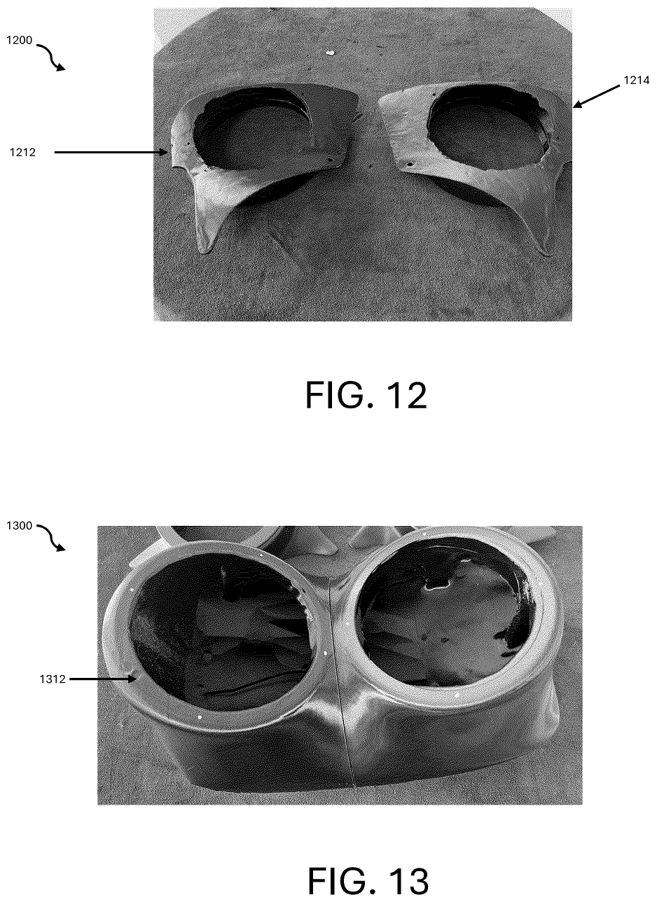

FIG. 12 shows generally at 1200 bottom perspective views of the pods 1212, 1214 illustrated in FIG. 11.

FIG. 13 shows generally at 1300 a top perspective view a dual driver rear pod 1312 for the first and second generation Hayabusa sports bike.

An example of kit options includes a first variation, with front left and right upper/main speakers with a choice of four speaker sizes. A second variation includes front left and right upper speakers as in the first variation, along with front lower left and right speaker with a choice of four sizes. Variation three includes variation two, along with a rear pod with the choices of the type, size(s) and number of speakers.

Advantageously, exemplary embodiments disclosed herein provide for open air audio on a motorcycle or a sport bike, with one or more mountable components provided with audio from a source via a wireless protocol. Further, exemplary kits provide choice of placement and components for a full or partial but upgradable system that provides a factory look specific to the motorcycle (e.g., sports bike).

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit, or individual or example materials, for purposes of clarity, it should be understood that the techniques of this disclosure may be performed by a combination of different units, modules or materials associated with, for example, audio system components.

What is claimed is:

1. A sports bike audio system, comprising:
at least one mountable component, the at least one mountable component comprising:
an enclosure configured to mount to a portion of a sports bike; and
a driver mounting ring configured to receive and secure a speaker driver of a predetermined size,
wherein the enclosure is configured to mount to the sports bike via screws and/or double-sided tape, and
wherein the enclosure is configured to mount to the sports bike so as to provide a factory look, such that it appears that the audio system originally came from the sports bike manufacturer.

2. A sports bike audio system in accordance with claim 1, wherein the enclosure comprises a durable plastic.

3. A sports bike audio system in accordance with claim 2, wherein the enclosure comprises acrylonitrile butadiene styrene.

4. A sports bike audio system in accordance with claim 1, wherein the enclosure is configured to mount to the sports bike via screws and double-sided tape.

5. A sports bike audio system in accordance with claim 1, wherein at least a portion of the enclosure is configured to provide an aerodynamic profile relative to the mounting position of the sports bike.

6. A sports bike audio system in accordance with claim 5, wherein the enclosure is configured to mount on an air duct cover of a sports bike at the upper front of the sports bike such that the driver mounting ring faces a rider.

7. A sports bike audio system in accordance with claim 6, wherein the enclosure has a cone shaped profile extending away from the driver mounting ring to provide an aerodynamic forward facing profile.

8. A sports bike audio system in accordance with claim 1, wherein the enclosure is configured to mount at a rear top portion of an air duct cover and on a faring side panel portion of a sports bike, with the faring side panel covering an open part of the enclosure on a bottom side thereof.

9. A sports bike audio system in accordance with claim 1, wherein the enclosure is configured to mount to the underside of the sports bike seat near the rear wheel.

10. A sports bike audio system in accordance with claim 9, wherein the enclosure is configured to house plural audio drivers.

11. A sports bike audio kit, comprising:
at least one mountable component, the at least one mountable component comprising:
an enclosure configured to mount to a portion of a sports bike; and
a driver mounting ring configured to receive and secure a speaker driver of a predetermined size,
wherein the enclosure is configured to mount to the sports bike via screws and/or double-sided tape, and
wherein the enclosure is configured to mount to the sports bike so as to provide a factory look, such that it appears that the audio system originally came from the sports bike manufacturer; and
a wireless audio receiving device having at least one audio connector configured to connect to one or more enclosures.

12. A sports bike audio kit in accordance with claim 11, comprising plural enclosures configured to mount to different portions of the sports bike.

13. A sports bike audio kit in accordance with claim 12, wherein at least one of the enclosures is an upper front enclosure configured to direct audio backwards towards a rider.

14. A sports bike audio kit in accordance with claim 12, wherein at least one of the enclosures is a lower front enclosure.

15. A sports bike audio kit in accordance with claim 12, wherein at least one the enclosures is a rear enclosure configured to mount under the seat of the sports bike.

16. A sports bike audio kit in accordance with claim 11, wherein the at least one enclosure comprises front left and right upper enclosures of a predetermined driver size.

17. A sports bike audio kit in accordance with claim 16, wherein the at least one enclosure additionally includes front lower left and right enclosures of a predetermined driver size.

18. A sports bike audio kit in accordance with claim 17, wherein the at least one enclosure additionally includes a rear enclosure having at least one driver mounting ring.
